(19) United States
(12) Patent Application Publication
(10) Pub. No.: US 2004/0124176 A1
(43) Pub. Date: Jul. 1, 2004

(54) Palsma etchingm method

(75) Inventors: Jen-Che Li, Tauyuan Hsien (TW); Jung-Te Lin, Miaoli (TW)

Correspondence Address: BACON & THOMAS, PLLC, 625 SLATERS LANE, FOURTH FLOOR, ALEXANDRIA, VA, 22314

(73) Assignee: ULTRATERA CORPORATION, Hsin Chu (TW)

(21) Appl. No.: 10/419,796

(22) Filed: Apr. 22, 2003

(30) Foreign Application Priority Data
Dec. 27, 2002 (TW) 91137642

(51) Int. Cl. C23F 1/00; B44C 1/22; C03C 15/00; C03C 25/68

(52) U.S. Cl. 216/67

(57) ABSTRACT

A plasma etching method for etching a substrate having a resin layer and an opening in an outer copper layer covering the resin layer is disclosed to include the step of contacting the outer surface of the copper layer with a chemical substance capable of making oxidation reaction with copper so as to form an oxide layer on the outer surface of the copper layer, and the step of employing a plasma etching technique of using a gas containing oxygen to form plasma to remove resin material from the resin layer corresponding to the opening of the copper layer.

### BACKGROUND OF THE INVENTION

1. Field of the Invention

The present invention relates generally to etching technology and, more particularly, to a plasma etching method.

2. Description of the Related Art

Plasma etching technology is widely employed to the manufacturing of electronic devices, for example, in IC package manufacturing process to clean residues from the face of IC substrate.

Recently, plasma etching technology has been intensively employed to the manufacturing of printed circuit boards, for example, to the formation of vias in printed circuit boards. The substrate of a printed circuit board may have a resin layer and two copper layers covered on the two sides of the resin layer. Alternatively, the substrate can be made having a stack of resin layers, copper circuits provide in between resin layers, and two copper layers covered on the top and bottom sides of the stack of copper layers. The processing of the aforesaid vias includes the steps of: (a) making holes on the outer surface of one or both two copper layers, enabling the holes reach the resin layer, and (b) delivering the substrate to a plasma etching machine to remove resin under the holes, forming the desired vias.

As well known, the principle of plasma etching is to decompose a gas into electrons, ions, and free radicals by continuously filling the gas into an environment of electric field of low tension and high strength, and then to use the free radicals to destroy the molecular chains of resin material, causing resin material to form into gas phase molecules of low molecular weight, and then to remove such gas phase molecules from the environment.

When applying plasma etching technology to the aforesaid via processing process, the gas commonly used to form plasma is oxygen (O₂), or oxygen-contained gas. The reaction of free radicals decomposed from oxygen under the aforesaid environment of electric field of low tension and high strength with resin causes resin to produce gas phase molecules of low molecular weight.

Further, during the processing of the aforesaid vias, the copper layers of the substrate are to mask the resin layer, enabling the oxygen free radicals to destroy the resin layer at the holes, forming the desired vias.

However, during plasma etching, a big ratio of the oxygen free radicals is reacted with the copper layers masking the resin layer and reduced into oxygen molecules (O₂), thus greatly lowering the density of oxygen free radicals in the environment of electric field of low tension and high strength and further lowering the etching rate and increasing the manufacturing cost.

Therefore, it is desirable to provide a plasma etching method, which eliminates the aforesaid drawbacks.

### SUMMARY OF THE INVENTION

The present invention has been accomplished under the circumstances in view. It is therefore the primary objective of the present invention to provide a plasma etching method, which achieves high etching rate.

To achieve this objective of the present invention, the plasma etching method is to put the surface of the copper layer of the substrate into contact with a chemical substance capable of making oxidation reaction with copper, so as to form an oxide layer on the outer surface of the copper layer to isolate the copper layer from oxygen free radicals during plasma etching process, preventing oxygen free radicals from being reduced into oxygen molecules (O₂).

### BRIEF DESCRIPTION OF THE DRAWINGS

FIG. 1 is a sectional view of a substrate used in a plasma etching method according to a first preferred embodiment of the present invention.

FIGS. 2-6 explain the steps of the plasma etching method according to the first preferred embodiment of the present invention.

FIG. 7 is a sectional view of a substrate used in a plasma etching method according to a second preferred embodiment of the present invention.

FIGS. 8-12 explain the steps of the plasma etching method according to the second preferred embodiment of the present invention.

### DETAILED DESCRIPTION OF THE INVENTION

The plasma etching method of the present invention can be employed to the fabrication of single layer PC (printed circuit) boards or multi-layer PC boards to make vias. The plasma etching method will be understood by way of the following two examples.

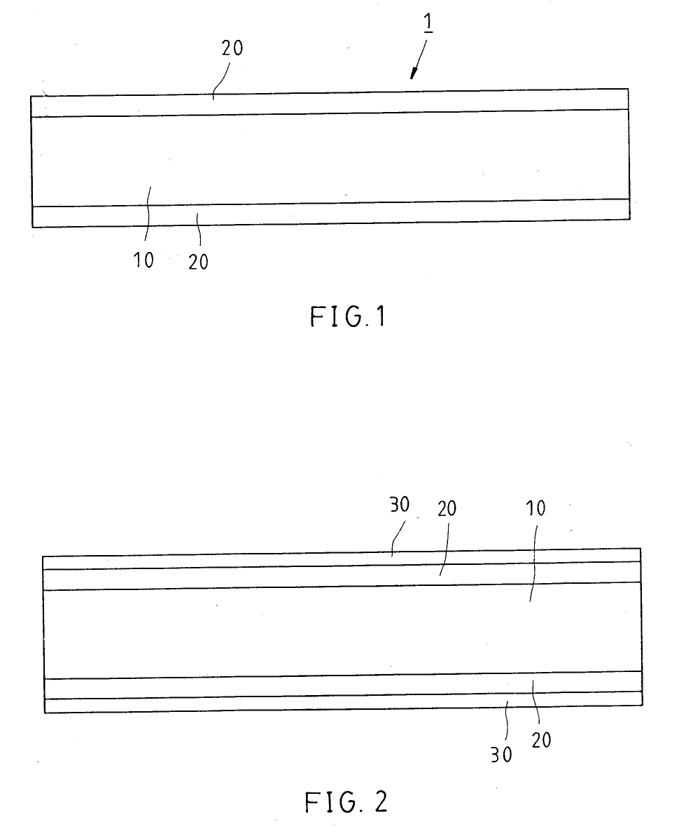

FIG. 1 is a sectional view of a PC board substrate 1 used in a plasma etching method according to the first preferred embodiment of the present invention. The substrate 1 comprises a resin layer 10, and two copper layers 20 covering two sides of the resin layer 10. The plasma etching method according to the first preferred embodiment of the present invention comprises a series of steps as outlined hereinafter.

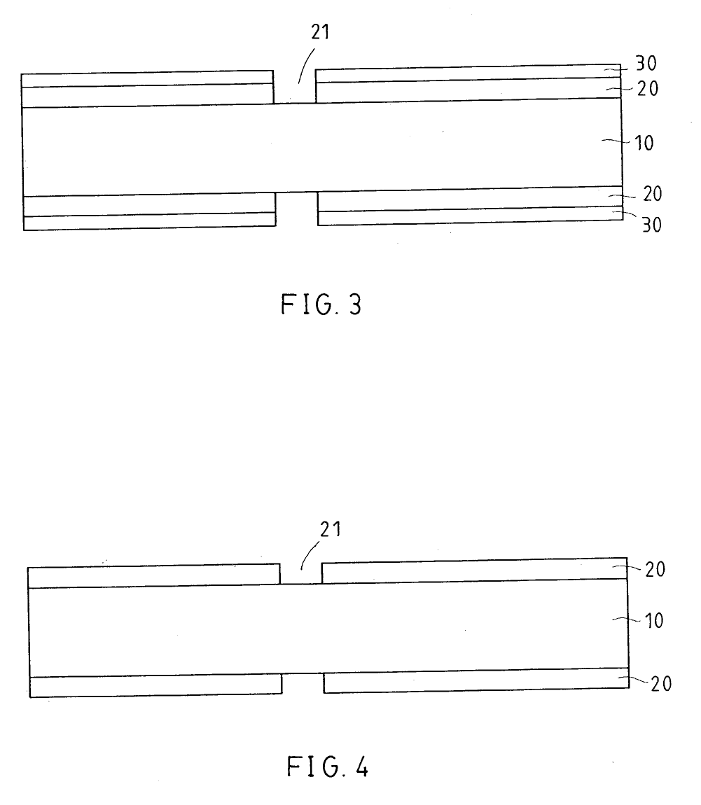

(a) Cover a respective piece of dry film photoresist 30 on the copper layers 20 respectively (see FIG. 2), then use exposure developing and chemical etching techniques to make a respective opening 21 on the copper layers 20 at relative locations (see FIG. 3), which opening 21 cut from the respective copper layer 20 to the surface of the resin layer 10, and then remove the two pieces of dry film photoresist 30 from the copper layers 20 by chemical solvent (see FIG. 4).

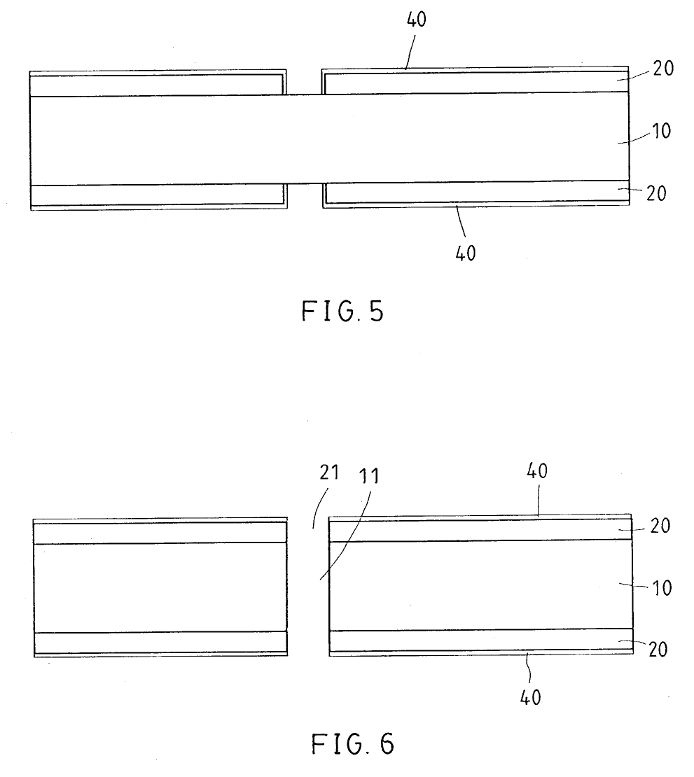

(b) Immerse the substrate 1 in a chemical bath capable of making oxidation reaction with copper, for enabling the exposed outer surface of each copper layer 20 to make oxidation reaction with the chemical solution in the chemical bath and further to form an oxide layer 40 on the surface of each copper layer 20 (see FIG. 5). The chemical solution used is a mixed solution of NaClO₂ of specific gravity 60 g/l and NaOH of specific gravity 80 g/l, and the formula of oxidation reaction between the chemical solution and the outer surfaces of the copper layers 20 is:

2Cu+2ClO₂→Cu₂O+ClO₃+Cl

Alternatively, the chemical solution can be obtained from the mixture of NaClO₂ of specific gravity 30 g/l, NaOH of specific gravity 10 g/l, and Na₃PO₄.12H₂O of specific gravity 10 g/l, and the formula of oxidation reaction between the chemical solution and the outer surfaces of the copper layers 20 is:

2Cu+2ClO₂→Cu₂O+ClO₃+Cl

Cu₂O+2ClO₂→CuO+ClO₃+Cl

The former causes the formation of a layer of Cu₂O on the outer surface of each copper layer 20. The later causes the formation of a layer of CuO on the surface of each copper layer 20.

(c) Employ the known plasma etching technique of using a gas containing oxygen to form plasma to remove resin material from the resin layer 10 corresponding the openings 21. During this step, the substrate 1 is placed in an environment of electric field of low tension and high strength, and then a flow of oxygen (O₂) or gas containing oxygen (O₂) is filled into the environment, causing oxygen (O₂) to be exited to release oxygen radicals. The oxygen radicals thus produced immediately react with the resin material corresponding to the openings 21 of the copper layers 20 at both sides of the resin layer 10, thereby causing the resin material to form into gas phase molecules of low molecular weight. The gas phase molecules of low molecular weight are then removed from the environment. Thus, vias are formed in the resin layer 10 corresponding to the openings 21 (see FIG. 6).

(d) Use a chemical solvent to remove the oxide layers 40 from the copper layers 20.

In the aforesaid plasma etching method, oxide layers 40 are respectively formed on the surface of the copper layers 20 of the substrate 1. The oxide layers 40 isolate the oxygen free radicals from the copper layers 20, preventing oxygen free radicals to be reduced into oxygen molecules (O₂). Therefore, the density of the oxygen free radicals in the environment of electric field of low tension and high strength is maintained unchanged, i.e., the plasma etching rate is improved.

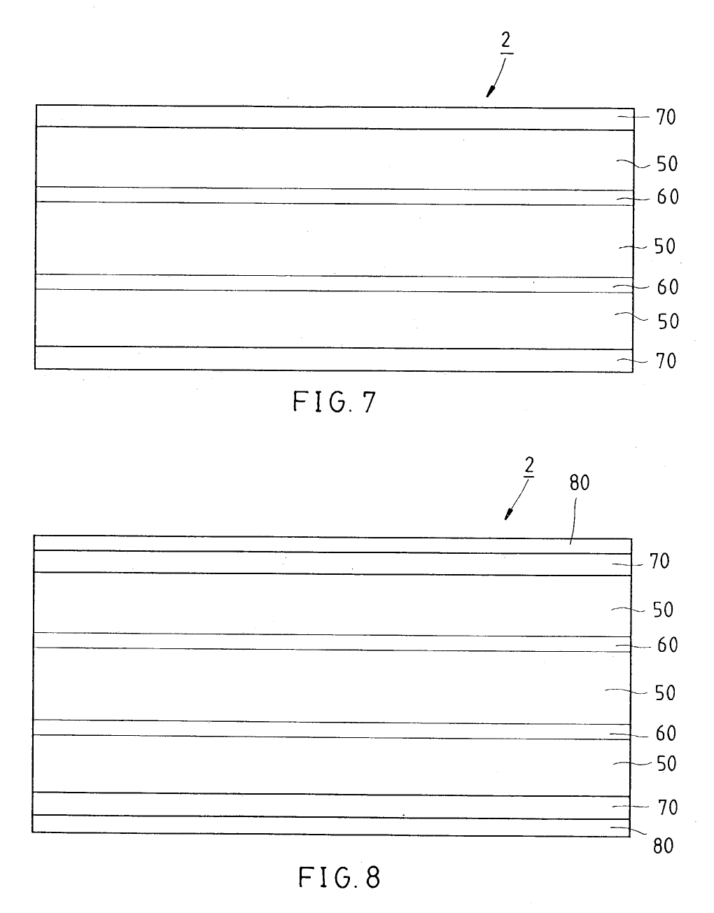

FIG. 7 is a sectional view of a PC board substrate 2 used in a plasma etching method according to the second preferred embodiment of the present invention. The substrate 2 comprises multiple resin layers 50 arranged in a stack, multiple copper circuits 60 respectively arranged in between the resin layers 50, and two copper layers 70 respectively covered on the two opposite outer resin layers 50a and 50b. The plasma etching method according to the second embodiment of the present invention comprises a series of steps as outlined hereinafter.

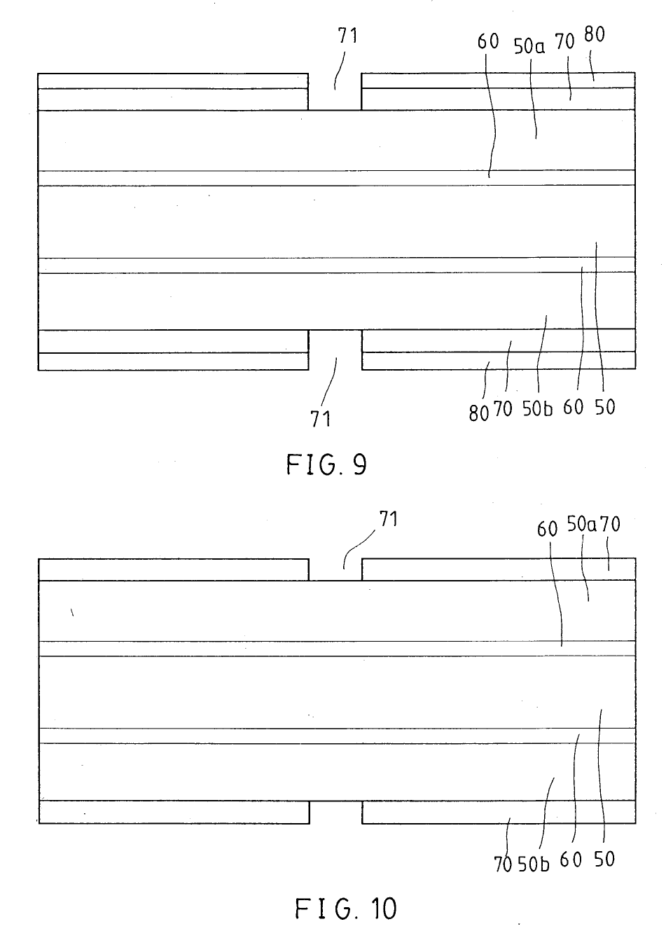

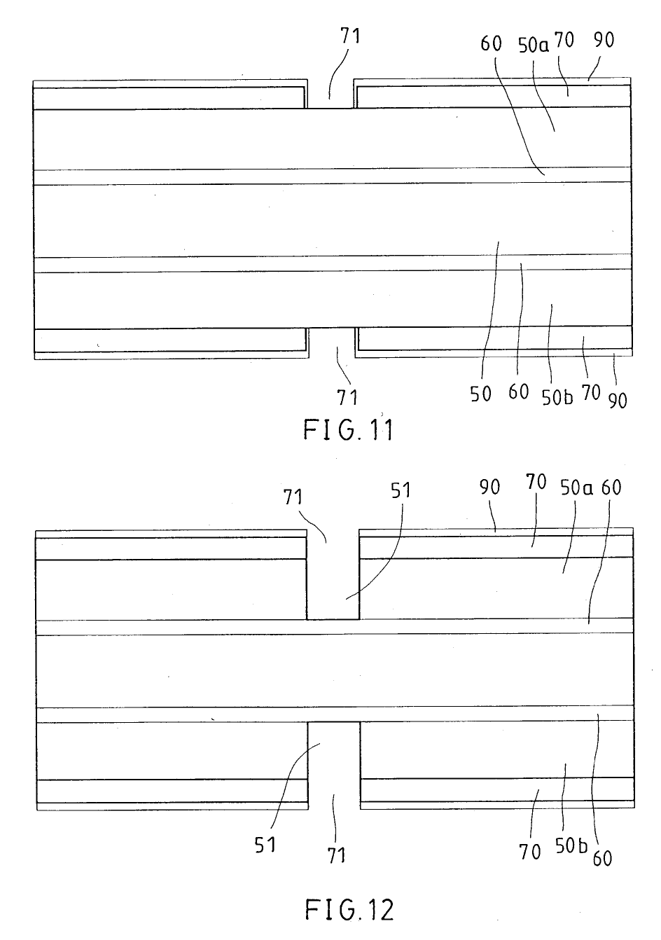

(a) Cover a respective piece of dry film photoresist 80 on the copper layers 70 respectively (see FIG. 8), then use exposure developing and chemical etching techniques to make a respective opening 71 on the two opposite outer copper layers 50a and 50b (see FIG. 9), which opening 71 cut from the respective copper layer 70 to the surface of the corresponding outer resin layer 50a or 50b, and then remove the two pieces of dry film photoresist 80 from the copper layers 70 by chemical solvent (see FIG. 10).

(b) Immerse the substrate 2 in a chemical bath capable of making oxidation reaction with copper, for enabling the exposed outer surfaces of the copper layers 70 to make oxidation reaction with the chemical solution in the chemical bath and further to form an oxide layer 90 on the surface of each copper layer 70 (see FIG. 10). This step is similar to the corresponding step of the aforesaid first preferred embodiment of the present invention.

(c) Employ the known plasma etching technique of using a gas containing oxygen to form plasma to remove resin material from the two opposite outer resin layers 50a and 50b corresponding to the openings 71, thus forming the desired via 51 (see FIG. 12). This step is similar to the corresponding step of the aforesaid first embodiment of the present invention.

(d) Use a chemical solvent to remove the oxide layers 90 from the copper layers 70.

Except the aforesaid two examples, the plasma etching method can also be employed to remove residues from vias made by means of laser drilling or mechanical drilling.

What is claimed is:

1. A plasma etching method for etching a substrate having at least one resin layer and at least one copper layer covered on said at least one resin layer, said copper layer having at least one opening extending to said resin layer, the plasma etching method comprising the steps of:
a) contacting an outer surface of said copper layer with a chemical substance capable of making oxidation reaction with copper, so as to form an oxide layer on the outer surface of said copper layer; and
b) employing a plasma etching technique of using a gas containing oxygen to form plasma to remove resin material from said resin layer corresponding to the opening of said copper layer.

2. The plasma etching method as claimed in claim 1, wherein said chemical substance is a mixed solution of NaClO₂ and NaOH.

3. The plasma etching method as claimed in claim 2, wherein the specific gravity of said NaClO₂ is 60 g/l; the specific gravity of said NaOH is 80 g/l.

4. The plasma etching method as claimed in claim 1, wherein said chemical substance is a mixed solution of NaClO₂, NaOH and Na₃PO₄.12H₂O.

5. The plasma etching method as claimed in claim 4, wherein the specific gravity of said NaClO₂ is 30 g/l; the specific gravity of said NaOH is 10 g/l; the specific gravity of said Na₃PO₄.12H₂O is 10 g/l.

6. The plasma etching method as claimed in claim 1, wherein said substrate comprises one said resin layer and two said copper layers respectively covered on two opposite sides of the resin layer, said two copper layers each having at least one said opening respectively extending from a respective exposed outer surface thereof to said resin layer, the opening of one of said two copper layers respectively corresponding to the opening of the other of said two copper layers.

7. The plasma etching method as claimed in claim 1, wherein said substrate comprises multiple said resin layers arranged in a stack, multiple copper circuits respectively provided in between said resin layers, and two said copper layers respectively covered on a respective outer surface of two outer resin layers of said multiple resin layers, said copper layers each having at least one said opening respectively extending from a respective exposed outer surface thereof to the corresponding outer resin layer.

8. The plasma etching method as claimed in claim 1 further comprising the step (c) of removing the oxide layer from the surface of said copper layer by means of the application of a chemical solvent after said step (b).
